(19) United States
(12) Patent Application Publication
(10) Pub. No.: US 2011/0280421 A1
(43) Pub. Date: Nov. 17, 2011

(54) DEVICE FOR AND A METHOD OF PROCESSING AUDIO SIGNALS

(75) Inventor: Christophe Macours, Hodeige (BE)

(73) Assignee: NXP B.V., Eindhoven (NL)

(21) Appl. No.: 12/674,174

(22) PCT Filed: Aug. 6, 2008
(86) PCT No.: PCT/IB2008/053156

§ 371 Date: Feb. 19, 2010

(30) Foreign Application Priority Data
Aug. 28, 2007 (EP) 07115140.1

(51) Int. Cl. H04R 1/40; H04R 5/02

(52) U.S. Cl. 381/303; 381/97

(57) ABSTRACT

A device for processing an audio signal is provided, wherein the processing device comprises a processing unit, and a determination unit, wherein the processing unit is adapted to receive first data associated with a first subsignal of the audio signal and second data associated with a second subsignal of the audio signal, and wherein the determination unit is adapted to determine a compensation value for one of the subsignals depending on a phase difference between the first subsignal and the second subsignal.

### FIELD OF THE INVENTION

The invention relates to a device for processing audio signals.

The invention further relates to a method of processing audio signals.

Moreover, the invention relates to a program element.

Further, the invention relates to a computer-readable medium.

### BACKGROUND OF THE INVENTION

Equalizers are widely used in audio systems to compensate room resonances, speakers frequency response, etc. In the past equalizers were implemented in an analogue way. Today most of them are implemented in a digital way via digital audio signal processing, directly embedded in the processor. Regarding the specific implementation of a digital equalizer, several solutions can be considered depending on the way to generate or implement the electronic components, like the filters or the processors. For example, the filters may be implemented as so-called finite impulse response (FIR) filters which allow for high-end equalization but involves high costs, or as so-called infinite impulse response (IIR) filters.

In particular, car acoustic equalization aims to compensate the deficiencies of the sound reproduction chain. In a car environment, these deficiencies are possibly caused by:
the non-ideal position of the loudspeakers,
the poor mounting of the loudspeakers,
the asymmetric listening position,
the acoustical response of the car cabin,
the presence of other passengers.

The equalization filters are usually obtained by performing, for each loudspeaker, one or more transfer function measurements around the target listening positions. The equalization filters are then derived from the measurements so as to obtain a flat frequency response.

To implement a digital equalizer in a system, a number of compromises have to be done. A high quality equalization can be achieved by increasing the complexity of the equalizer but it also increases the implementation costs.

Most car audio equalization systems provide an amplitude correction by means of minimum phase IIR or FIR filters. Common phase correction is usually implemented in the form of a pure delay applied to the left loudspeakers, since the listener is usually sitting at the driver position, to obtain a time alignment with the right loudspeaker. However, adding such a delay may shift the sound image to the right whereas it is desired to maintain it in front of the driver.

Thus, there may be a need to provide an improved audio signal-processing device that may have a reasonable complexity and provides an efficient equalization of audio signals.

### SUMMARY OF THE INVENTION

It may be an object of the invention to provide an efficient audio signal processing device and an efficient method of audio data processing.

In order to achieve the object defined above, a device for processing audio signals, a method of processing audio signals, a program element, and a computer-readable medium according to the independent claims are provided.

According to an exemplary embodiment a device for processing an audio signal is provided, wherein the processing device comprises a processing unit, and a determination unit, wherein the processing unit is adapted to receive first data associated with a first subsignal of the audio signal and second data associated with a second subsignal of the audio signal, and wherein the determination unit is adapted to determine a compensation value for one of the subsignals depending on a phase difference between the first subsignal and the second subsignal. In particular, the phase difference may be the difference of the so-called excess-phase part of the subsignals.

According to an exemplary embodiment a method of compensating an audio signal is provided, wherein the method comprises receiving a first subsignal of the audio signal the first subsignal having a first phase, receiving a second subsignal of the audio signal the second subsignal having a second phase, and determining a phase difference between the first phase and the second phase. Furthermore, the method comprises compensating the audio signal by adding a compensation signal to one of the first subsignal and the second subsignal, wherein the compensation depends on the phase difference. In particular, the compensation signal is only added to one of the subsignal but not to the other one. That is, only one of the subsignals may be compensated, wherein the value, strength, amplitude, type or phase of the compensation signal may be dependent on the difference between the phase of the first subsignal and the phase of the second subsignal. In other words a pair of subsignals may be compensated by compensating only one of the two subsignals using a compensation value dependent on the phase difference between the two subsignals of the pair of subsignals. However, it may also be possible to compensate both subsignals of a pair of subsignals.

According to an exemplary embodiment a program element is provided, which, when being executed by a processor, is adapted to control or carry out a method according to an exemplary embodiment.

According to an exemplary embodiment a computer-readable medium is provided, in which a computer program is stored which, when being executed by a processor, is adapted to control or carry out a method according to an exemplary embodiment.

The audio signal processing device according to embodiments of the invention may be realized by a computer program, that is, by software, or by using one or more special electronic optimization circuits, that is in hardware, or in hybrid form, that is by means of software components and hardware components.

In this application, the term “subsignal” may particularly denote any signal formed by a portion of a total signal, e.g. a subsignal may be an audio signal for a right loudspeaker or an audio signal for the left loudspeaker of a stereo audio signal.

In this application, the term “compensation signal” may particularly denote any signal which may be used to compensate a given signal, e.g. an audio signal. According to this application such a compensation signal may be provided by using a filter, e.g. by simply introducing a filter into the signal path. Additionally, such a compensation signal may be actively generated by another signal source and then be added to the subsignal to be compensated.

By providing a compensation signal depending on or associated with a phase difference between a pair of subsignals and adding this compensation signal to only one of the subsignals of the pair of signals an efficient way and less complex method to provide a phase equalization may be provided. In particular, compared to a method compensating both of the subsignals the method according to the exemplary embodiment may be simplified, while possibly still providing a reasonable phase equalization, since it may be that the most perceptually relevant part of a phase correction or equalization may be the relative phase correction between the individual subsignals, e.g. signals for loudspeakers. In particular, there may be only a small subjective difference between applying a first phase correction to a first subsignal and a second phase correction to a second subsignal, and applying a phase correction based on the phase difference to only one of the subsignals. This effect may be explainable by the fact that in both cases a coherence between the first subsignal and the second subsignal may be restored or may at least be improved. The resulting phase, may exhibit a much simpler behaviour that may be better suited for an IIR approximation.

A method according to an exemplary embodiment may also be suitable to provide amplitude and phase correction without the need to provide a long FIR filter. Such common FIR filters often have more than 1000 taps per channel at 44.1 kHz for example, which would be extremely costly for typical DSPs in embedded platforms.

Thus, a gist of an exemplary aspect of the invention may be seen in the fact that instead of applying a phase correction to both subsignals of an audio signal, wherein one subsignal may relate to a left loudspeaker, while the other one may relate to a right loudspeaker, for example, a phase correction is only applied to one of subsignals. However, in this case the phase correction does not relate to the single phases of the subsignals but to the phase difference of the two subsignals.

Next, further exemplary embodiments of the invention will be described.

In the following, further exemplary embodiments of the device for processing an audio signal will be explained. However, these embodiments also apply for the method of processing audio signals, for the program element and for the computer-readable medium.

According to another exemplary embodiment of the device the processing unit comprises a first processing block which is adapted to process the first data and a second processing block which is adapted to process the second data.

According to another exemplary embodiment of the device the processing unit comprises a first IIR filter and a second HR filter, wherein the first IIR filter is adapted to filter the first subsignal, and wherein the second IIR filter is adapted to filter the second subsignal. In particular, the IIR filters may be low order IIR filters.

In the following, further exemplary embodiments of the method of processing audio signals will be explained. However, these embodiments also apply for the device for processing audio signals, for the program element and for the computer-readable medium.

According to another exemplary embodiment of the method the compensation signal relates to an IIR allpass section. In particular, the compensation itself may be performed using one or more IIR allpass sections. Specifically, the IIR allpass sections may be only added to one of the two subsignals and not to both of them. Furthermore, the decision to which of the two subsignals the IIR allpass sections are added may be based on a trend of the phase difference, e.g. whether the phase difference is inclining or declining. For example, the first subsignal and the second subsignal may form a pair of corresponding subsignals, like subsignals relating to a stereo audio signal. The method may also be deployed for more than one pair of subsignals, i.e. for more than one stereo audio signal or to one audio signal having more than one pair of subsignals, wherein preferably for each pair of subsignals the compensating method may be performed.

Thus, it may be possible to provide respective subsignals to more than two loud speakers. Furthermore, the using of IIR allpass sections or filters may be a suitable way to implement a phase correction in an efficient incomplex way compared to the using of FIR filters.

According to another exemplary embodiment of the method the IIR allpass section is an IIR allpass biquad section. In particular, the IIR filters or IIR allpass sections are adapted as cascading IIR allpass biquad sections.

According to another exemplary embodiment of the method the compensation is only performed in case that the determined phase difference has a predetermined value. In particular, the predetermined value of the phase difference may be 180°.

Thus, the phase difference may be approximated by focusing on the 180° crossing points which indicate a phase reversal between the first and the second subsignal, e.g. left and right channel of a stereo audio signal. In other words, it may be possible to minimize the difference between an original, e.g. measured phase difference, and approximated curves, e.g. by an IIR allpass section, around 180°. When at least compensation signals or filters are added at each 180° crossing it may be possible to avoid an inversion of the phase correlation between the two subsignals.

According to another exemplary embodiment the method further comprises determining a phase difference curve by determining phase differences between the first phase and the second phase for different frequencies. That is, a transfer function may be determined. For example, a mapping of the phase difference, e.g. the phase difference of the so-called excess phase parts, for all frequencies which are important for sound reproduction may be performed. Such important frequencies may in particular be the frequencies which correspond to the human hearing which ranges between about 16 Hz and 20 kHz. The phase difference curve may be measured by using a microphone placed at respective positions a phase compensation or equalization has to be performed. That is, so-called transfer functions may be measured indicating the effect of the frequency on the phase difference for different positions. From this transfer function a filter may be derivable which may be used to compensate the phase of one subsignal.

According to another exemplary embodiment of the method parameters of the allpass biquad section are determined depending on a frequency of a 180° phase difference and on a gradient of the phase difference curve. That is, the two free parameters, frequency and slope of the of an allpass biquad section may be given by the frequency f_{c}, relating to the 180° crossing, and the slope of the respective curve at that frequency.

According to another exemplary embodiment of the method a decision which one of the first subsignal and the second subsignal is compensated for depends on the algebraic sign of the gradient of the phase difference curve. In particular, the first subsignal may be compensated for in case the gradient at a specific 180° phase difference is negative, while the second subsignal may be compensated for in case the gradient at a specific 180° phase difference is positive.

According to another exemplary embodiment of the method the first subsignal corresponds to a right part of the audio signal of a stereo audio signal, and the second subsignal corresponds to a left part of the audio signal of the stereo audio signal. In particular, the first and second subsignals may be digital, i.e. the audio signal may be a digital audio signal.

According to another exemplary embodiment of the method a compensation is only performed up to frequencies of the audio signal of 3 kHz. In particular, the compensation may be only performed up to frequencies of 2 kHz, more particularly up to 1 kHz. That is, only audio signals having a frequency between 20 Hz and 3 kHz, particularly between 20 Hz and 2 kHz, and more specifically between 20 Hz and 1 kHz may be compensated.

Summarizing an exemplary aspect of the invention may be seen providing a phase equalization using IIR equalization filters instead of FIR equalization filters. According to this aspect the most relevant contributions of phase equalization are considered possibly leading to a restoring of lateral coherence between subsignals relating to a left loudspeaker and a right loudspeaker. The phase equalization may be performed by applying allpass biquad sections on the left and/or right channels to compensate phase difference crossings at 180°. The resulting IIR filters may have high performance or even perfect allpass characteristic and may easily fine-tuned if necessary. Thus, according to this exemplary aspect an efficient, low complex phase equalization method may be provided having a good performance, wherein the method only uses low processor resources. In particular, an improved sound quality while using relatively low-order IIR filters may be possible. These low-order IIR filters may be computationally much more efficient than FIR filters. Such a method may be implemented in all systems having an audio equalizer equipped with at least two loudspeakers.

According to another exemplary aspect a signal processing device is provided, which comprises at least one left channel processing block adapted to process a left channel signal, and at least one right channel processing block adapted to process a right channel signal. Furthermore, a first low order IIR filter in the left channel processing block, and a second low order IIR filter in the right channel processing block are implemented. Additionally the signal processing device comprises a compensating unit adapted to compensate within the channel signals phase difference crossings at 180° by applying allpass sections on the left and right channels signals. In an embodiment the IIR filters are adapted as cascading IIR allpass biquad sections.

The exemplary embodiments and aspects defined above and further aspects of the invention are apparent from the examples of embodiment to be described hereinafter and are explained with reference to these examples of embodiment. Features which are described in the connection with one exemplary embodiment or exemplary aspect may be combined with features of another exemplary embodiments or aspects.

### BRIEF DESCRIPTION OF THE DRAWINGS

The invention will be described in more detail hereinafter with reference to examples of embodiment but to which the invention is not limited.

FIG. 1 schematically illustrates a general idea of an exemplary embodiment.

FIG. 2 schematically shows a reference loud speaker system.

FIG. 3 schematically depicts an example of an excess phase difference.

FIG. 4 schematically depicts magnitude and phase frequency responses of an allpass biquad section.

FIG. 5 schematically depicts an application example of a method according to an exemplary embodiment.

### DESCRIPTION OF EMBODIMENTS

The illustration in the drawing is schematically. In different drawings, similar or identical elements are provided with the similar or identical reference signs.

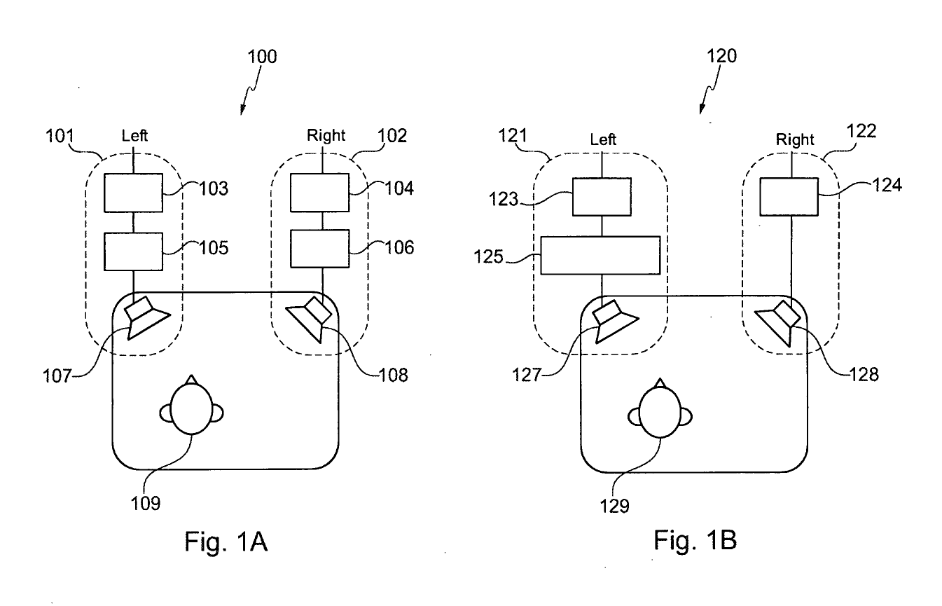

In the following, referring to FIGS. 1 to 5 some basic principles of data processing in a device according to an exemplary embodiment will be explained.

FIG. 1 schematically shows a general idea of an exemplary embodiment. FIG. 1A shows an audio system 100 comprising two channels representing a left channel 101 and a right channel 102. Each channel comprises an amplitude equalization 103 and 104, a phase equalization 105 and 106, and a loud speaker 107 and 108, respectively. Furthermore, a listener is schematically depicted as 109. Thus, FIG. 1A schematically depicts an audio system having an independent phase correction or phase equalization implemented for each channel. Contrary to that, FIG. 1B schematically shows an audio system 120 comprising two channels representing a left channel 121 and a right channel 122. Each channel comprises an amplitude equalization 123 and 124, and a loudspeaker 127 and 128, respectively. However, a phase equalization 125 is only performed for the left channel. However, the respective phase equalization 125 is based on the phase difference between the two subsignals. Furthermore, a listener is schematically depicted as 129.

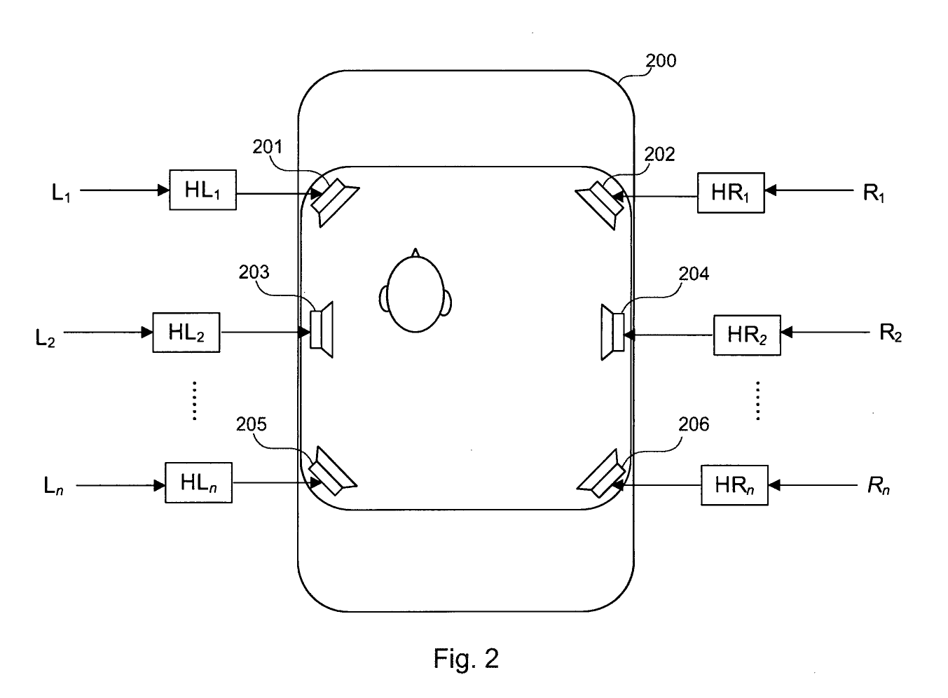

FIG. 2 schematically depicts a reference loudspeaker system arranged in a car 200. The loud speaker system comprises a plurality of loud speakers of which six are schematically depicted as 201, 202, 203, 204, 205, and 206 in FIG. 2. The six loudspeakers build three pairs of loudspeakers, wherein each pair comprises one left loudspeaker and one right loudspeaker. It is of course possible that more than three pairs of loudspeakers are arranged in a car. A loudspeaker configuration as shown in FIG. 2 is representative of traditional home audio systems, e.g. stereo or multichannel, but also car audio systems. In FIG. 2 respective left subsignals and right subsignals are depicted as arrows L₁, L₂, Lₙ, and R₁, R₂, Rₙ, respectively. Furthermore, corresponding non-minimum phase FIR car equalization filters are schematically depicted as HL₁, HL₂, HRₙ, HR₁, HR₂, and HRₙ and which are associated with the respective audio subsignals L₁, L₂, Lₙ and R₁, R₂, Rₙ, respectively.

For each pair of left and right loud speaker, e.g. pair i, HLᵢ and HRᵢ are split into their minimum phase parts, HLAᵢ and HRAᵢ, and excess phase parts HLPᵢ and HRPᵢ, respectively, such that HLᵢ=HLAᵢ×HLPᵢ and HRᵢ=HRAᵢ×HRPᵢ. Using prior art methods may do this. In particular, the minimum phase parts, HLAᵢ and HRAᵢ may be approximated by relatively low order IIR filters using prior art methods.

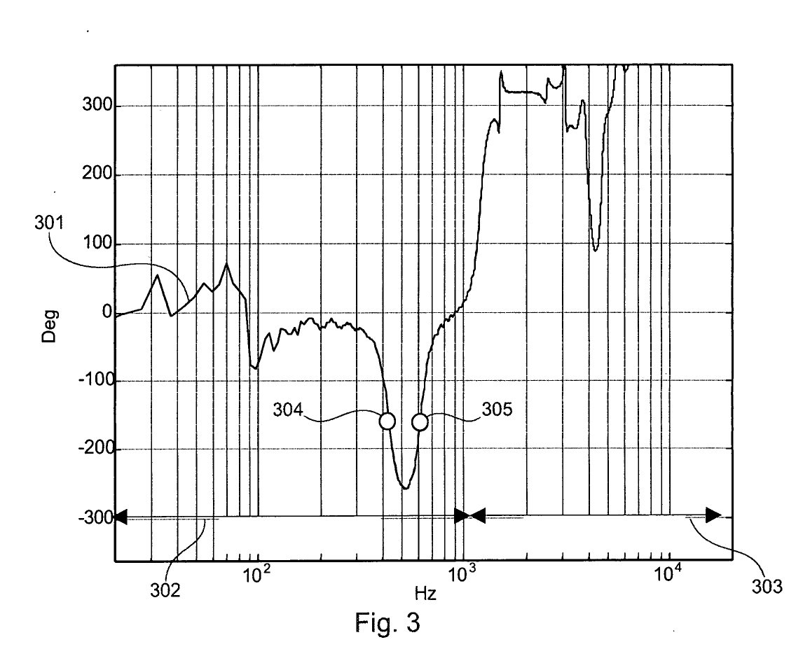

The excess phase difference PDᵢ is then computed as PDᵢ=HLPᵢ−HRPᵢ. An example of this phase difference is depicted in FIG. 3.

FIG. 3 schematically depicts an example of an excess phase difference PDᵢ. In particular, FIG. 3 depicts as line 301 the phase difference in degree for the respective frequencies of the audio signal, i.e. the phase difference PDᵢ for each frequency of the two subsignals for the left and right loudspeakers. In particular, the difference is calculated by subtracting the excess phase of the right loudspeaker from the excess phase of the left loudspeaker. However, it is of course possible as well to calculate the phase difference by subtracting excess phase of the left loudspeaker from the excess phase of the right loudspeaker. By arrows 302 and 303 a relevant part and a non-relevant part, respectively, are indicated. In particular, frequencies above 1 to 2 kHz may be disregarded, because at those frequencies, the human ear is not sensitive to left/right phase differences, since the wavelength at this frequencies is much smaller than the head diameter and phase ambiguity occurs. Furthermore, two 180° crossings points are indicated in FIG. 3, namely by dot 304 and dot 305.

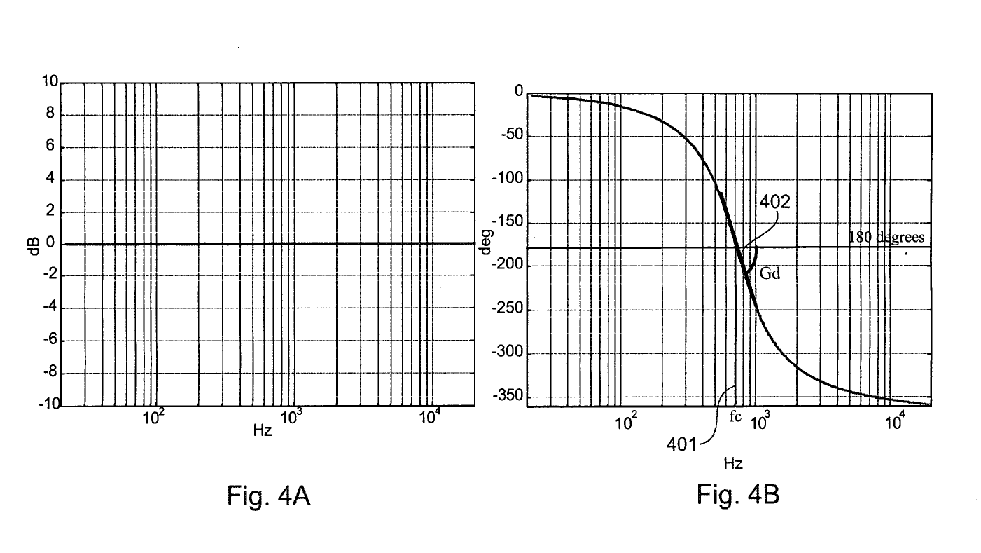

A basic idea of the exemplary embodiment shown and described in connection with the figures may be to approximate the phase difference PDᵢ by focussing on the 180° crossing points, which indicate a phase reversal between left and right channels. In other words, the priority is to try to minimize the difference between the original and approximated curves around 180°. According to one exemplary embodiment the left and right IIR phase equalization filters may be built by cascading IIR allpass biquad sections. A typical HR allpass biquad section has a frequency magnitude and phase responses as shown in FIG. 4, which will be described in the following.

FIG. 4 schematically depicts magnitude and phase frequency responses of an allpass biquad section, wherein FIG. 4A shows a magnitude frequency response while FIG. 4B shows a phase frequency response of an allpass biquad section. Such phase frequency responses allways decreases from 0° at DC, i.e. frequency zero, down to 360° at the Nyquist frequency. The respective allpass biquad section has two degrees of freedom, namely the so-called “180° crossing” frequency f_{c} and the slope or gradient of the curve at that frequency f_{c}, which slope is typically called Group Delay (Gd). In FIG. 4B the respective frequency f_{c} and the slope Gd are labelled by the reference signs 401 and 402, respectively.

In the following, an exemplary embodiment that may be used in connection with the calculated phase differences shown in FIG. 3 will be shortly described. According to this exemplary embodiment IIRPhase_{Li} and IIRPhase_{Ri} are the IIR phase equalization filters to construct for the i^{th} row or i^{th} pair of loudspeakers. Initially, both filters may be empty. For each 180 degrees crossing j of the phase curve PDᵢ, the corresponding crossing frequencies (fcⱼ) and the slope (Gdⱼ) of the phase curve are collected. According to this exemplary embodiment an IIR allpass biquad section is added to the left channel having its 180° crossing at fcⱼ and a group delay at fcⱼ equal to Gdⱼ if Gdⱼ is positive. In case Gdⱼ is negative, an IIR allpass biquad section is added to the right channel having its 180° crossing at fcⱼ and a group delay at fcⱼ equal to Gdⱼ.

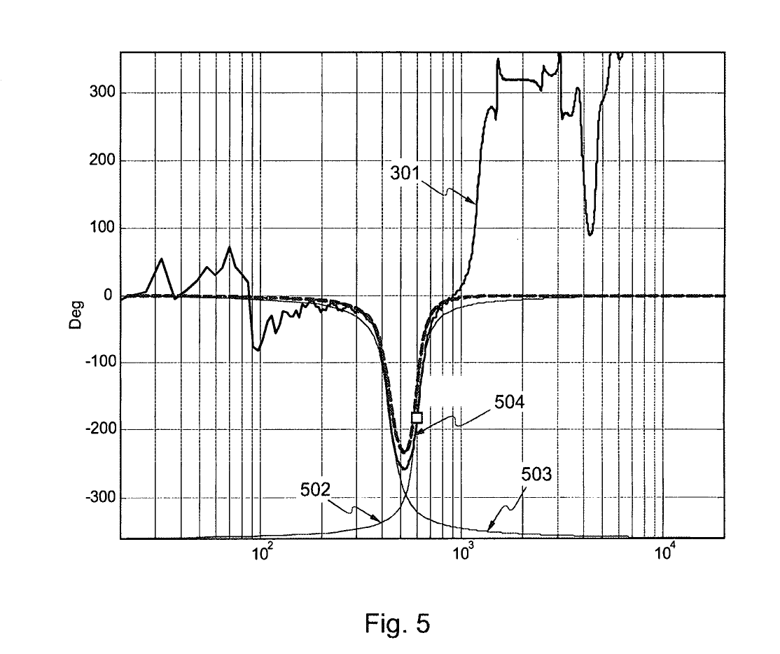

FIG. 5 schematically illustrates exemplary results of a method according to an exemplary embodiment. FIG. 5 shows, for frequencies between 20 Hz and 10 kHz, a target phase response 301 which is identical to a phase difference PDᵢ and which is in particular identical to the PDᵢ shown in FIG. 3, since the same embodiment is used. Furthermore, two IIR allpass biquad sections or filters are depicted in FIG. 5 as line 502 and 503. The number of two relates to the number of 180° crossings of the phase difference in the region of the phase dip at about 500 Hz in FIG. 5. In FIG. 5 the line 502 relates to the allpass biquad section for the left loudspeaker, while line 503 relates to the allpass biquad section of the right loudspeaker. The approximated phase difference obtained between the left and right channels is indicated as dotted line 504 in FIG. 5. As can be seen from FIG. 5 up to a cutoff frequency of about 1 kHz the approximated phase difference is a good approximation for the calculated target response. Thus, the used method is suitable to provide an efficient phase correction, in particular, since perceptual tests showed that most of the correction is subjectively due to the contribution at about 500 Hz.

It should be noted that the term “comprising” does not exclude other elements or features and the “a” or “an” does not exclude a plurality. Also elements described in association with different embodiments or aspects may be combined. It should also be noted that reference signs in the claims shall not be construed as limiting the scope of the claims.

1. An audio signal processing device for processing an audio signal, the processing device comprising:
a processing unit, and
a determination unit,
wherein the processing unit is adapted to receive first data associated with a first subsignal of the audio signal and second data associated with a second subsignal of the audio signal, and
wherein the determination unit is adapted to determine a compensation value for one of the subsignals depending on a phase difference between the first subsignal and the second subsignal.

2. The audio data processing device according claim 1,
wherein the processing unit comprises a first processing block which is adapted to process the first data and a second processing block which is adapted to process the second data.

3. The audio data processing device according to claim 1,
wherein the processing unit comprises a first IIR filter and a second IIR filter,
wherein the first IIR filter is adapted to filter the first subsignal, and
wherein the second IIR filter is adapted to filter the second subsignal.

4. A method of compensating an audio signal, the method comprising:
receiving a first subsignal of the audio signal the first subsignal having a first phase,
receiving a second subsignal of the audio signal the second subsignal having a second phase,
determining a phase difference between the first phase and the second phase, and
compensating the audio signal by adding a compensating signal to one of the first subsignal and the second subsignal, wherein the compensation signal depends on the phase difference.

5. The method according to claim 4,
wherein the compensation signal relates to one or more IIR allpass sections, in particular one or more IIR allpass sections.

6. The method according to claim 4,
wherein the compensation is only performed in case that the determined phase difference has a predetermined value.

7. The method according to claim 4, further comprising:
determining a phase difference curve by determining phase differences between the first phase and the second phase for different frequencies.

8. The method according to claim 7,
wherein parameters of an allpass biquad section are determined depending on a frequency of a 180° phase difference and on a gradient of the phase difference curve at the 180° phase crossing.

9. The method according to claim 7,
wherein a decision which one of the first subsignal and the second subsignal is compensated depends on the algebraic sign of the gradient of the phase difference curve.

10. The method according to claim 4,
wherein the first subsignal of the audio signal corresponds to a right part of the audio signal of a stereo audio signal, and
wherein the second subsignal of the audio signal corresponds to a left part of the audio signal of the stereo audio signal.

11. The method according to claim 4,
wherein the first subsignal and the second subsignal are digital signals.

12. The method according to claim 4,
wherein a compensation is only performed up to frequencies of the audio signal of 3 kHz.

13. A program element, which, when being executed by a processor, is adapted to control or carry out a method according to claim 4.

14. A computer-readable medium, in which a computer program is stored which, when being executed by a processor, is adapted to control or carry out a method according to claim 4.
